(19) United States
(12) Patent Application Publication
(10) Pub. No.: US 2010/0260956 A1
(43) Pub. Date: Oct. 14, 2010

(54) HYDROLYSIS RESISTANT CELLULAR MATERIAL, THE COMPOSITION AND METHOD FOR THE PRODUCTION THEREOF

(75) Inventor: Yves Lehmann, Liernu (BE)

Correspondence Address: OBLON, SPIVAK, MCCLELLAND MAIER & NEUSTADT, L.L.P., 1940 DUKE STREET, ALEXANDRIA, VA, 22314, US

(73) Assignee: SAINT-GOBAIN PERFORMANCE PLASTICS CHAINEUX, CHAINEUX (BE)

(21) Appl. No.: 12/063,823

(22) PCT Filed: Aug. 3, 2006
(86) PCT No.: PCT/IB06/52674

§ 371 Date: Apr. 28, 2008

(30) Foreign Application Priority Data
Aug. 17, 2005 (FR) 0552529

(51) Int. Cl. C08L 75/00; C08J 9/00; B32B 1/08

(52) U.S. Cl. 428/36.5; 521/54; 521/81

(57) ABSTRACT

The use of at least one polyol (P) chosen from polyester and polyether polyols grafted by chains of at least one of the following: polystyrene, polyacrylonitrile and styrene/acrylonitrile copolymers and from polyester and polyether polyols in which at least one of the following: polystyrene, polyacrylonitrile and styrene/acrylonitrile copolymers is dispersed, as an incorporation into the formulation of the polyol constituent or of the polyol-polyamine constituent of a polyurethane forming the polymer matrix of a hydrolysis-resistant soft cellular material, said polyol or polyols (P) representing at least one part of said polyol constituent or at least one part of the polyol fraction of said polyol-polyamine constituent.

The present invention relates to cellular materials, more particularly to soft and flexible materials made from expanded polyurethane polymer, especially those that can be used to make sealing, insulating or damping components.

Such materials can be used, among others, in the automotive industry and in industries that manufacture various electrical devices. By way of example of their use in the automotive industry, mention may be made of foamed seals that are intended for fitting onto types of doors, door trims, headlights, air conditioning units, etc.

The production of these foamed polyurethane seals is carried out by depositing, by extrusion onto the part that has to be equipped with the seal, a material of suitable viscosity that develops into a foam by crosslinking in the open air or in a controlled atmosphere. The application of the material may be able to be carried out in a groove, on a former or on a smooth surface.

Foam layers can also be manufactured, the material of suitable viscosity being deposited by extrusion as a sheet onto a medium such as paper or a glass fabric impregnated with silicone or with a fluorinated product, etc., or a plastic film, then, after adjustment of the sheet thickness and foaming and crosslinking of the product, the layer is peeled off then cut to the desired dimensions of the seals. Alternatively, the foam is laid on a non-nonstick substrate, such as a polyester film, that forms an integral part of the finished cellular product.

The material to be deposited may be prepared in advance and be of a stable form that can be stored in an inert atmosphere until it is used. Such a system is said to be a “one-component” system. Or else the material to be deposited is formed from components stored separately from one another and mixed together in appropriate quantities just before application, using metering and mixing devices. This system is said to be a “two-component” system.

For a more detailed description of these techniques, the reader may refer to European patent 0 930 323 B1 in the name of the applicant company.

These foamed materials must pass many tests to verify that their mechanical properties, their temperature behavior and their aging resistance, especially in a humid environment, meet the standards established by automobile manufacturers. These standards are becoming increasingly stringent.

There is a risk of hydrolysis of the foamed polyurethane seals when in prolonged contact with water. Automobile manufacturers have developed stringent aging tests in pressurized autoclaves that make it possible to evaluate the hydrolysis resistance. To the knowledge of the applicant company, the foamed polyurethane seals currently on the market do not give results that meet the latest requirements of automobile manufacturers.

Seeking to improve such foamed materials, the applicant company has discovered that the use of a specific family of polyols for incorporating into the formulation of the polymer matrix makes it possible to achieve the desired results. It is this use which is the subject of the present invention.

Therefore one subject of the invention is firstly the use of at least one polyol (P) chosen from polyester and polyether polyols grafted by chains of at least one of the following: polystyrene, polyacrylonitrile and styrene/polyacrylonitrile copolymers and from polyester and polyether polyols in which at least one of the following: polystyrene, polyacrylonitrile and styrene/acrylonitrile copolymers is dispersed, as an incorporation into the formulation of the polyol constituent or of the polyol-polyamine constituent of a polyurethane forming the polymer matrix of a hydrolysis-resistant soft cellular material, said polyol or polyols (P) representing at least one part of said polyol constituent or at least one part of the polyol fraction of said polyol-polyamine constituent.

The term “styrene/acrylonitrile copolymer” is understood to mean random copolymers, block copolymers and also combinations thereof.

The polyols (P) according to the invention are especially polyether and polyester polyols, onto the backbone of which are grafted segments derived from at least one of the following: styrene and acrylonitrile. The backbones of the polyether and polyester polyols are for example a poly(ethylene oxide), a poly(propylene oxide) or a poly(propylene oxide-ethylene oxide).

In a graft PO/PE polyether polyol, the backbone is: a copolymer incorporating ethylene oxide units and propylene oxide units, such copolymers possibly being block copolymers, in which an ethylene oxide oligomer is attached to a propylene oxide oligomer; random coploymers, where the ethylene oxide subunits and the propylene oxide subunits are randomly distributed; or polymers which are a combination of block polymers and random polymers.

Examples of graft polyether polyols may be found in U.S. Pat. No. 4,670,477 in which they are described as modified polyether polyols. Poly(ethylene oxide/propylene oxide) ether polyols, in which at least one of either polystyrene or polyacrylonitrile is dispersed, are also described.

Graft polyols can be obtained commercially from several companies. Mention may be made of the polyols called “Polymer Polyol” by Bayer, those called “Graft Polyol” by BASF and those called “Co-polymer Polyol” by Dow.

The polyol or polyols (P) advantageously represent at least 5% by weight, especially 10% by weight, of the polyol constituent or of the polyol-polyamine constituent of the polyurethane prepolymer.

The cellular material may be in strip, sheet, strand or tube form for a seal, or part of a seal, for sealing, insulating or damping.

Another subject of the present invention is a composition intended for forming the polyurethane polymer matrix of a hydrolysis-resistant soft cellular material, characterized in that it comprises:

(A) a polyol constituent formed from at least one polyol of functionality at least equal to 2 or a polyol-polyamine constituent formed from at least one polyol of functionality at least equal to 2 and from at least one polyamine of functionality at least equal to 2, at least one part of said polyol constituent or of the polyol fraction of said polyol-polyamine constituent being formed by at least one polyol (P) chosen from polyester and polyether polyols grafted by chains of at least one of the following: polystyrene, polyacrylonitrile and styrene/acrylonitrile copolymers and from polyester and polyether polyols in which at least one of the following: polystyrene, polyacrylonitrile and styrene/acrylonitrile copolymers is dispersed; and

(B) a polyisocyanate constituent,

the quantities of constituents (A) and (B) being especially chosen in such as way that said constituents (A) and (B) are able to react in an NCO/(OH+NH₂) molar ratio of at least 2, especially of about 2 to 5, preferentially 2 to 3.5.

The polyol or polyols other than the polyols (P) and the polyamines capable of being incorporated into the formulation of constituent (A) may be chosen from the polyols and polyamines respectively having a backbone of the type: polyester; polycaprolactone; polyether; polyolefin, especially hydroxylated EVA copolymer; saturated or unsaturated polybutadiene; polyisoprene; and polydimethylsiloxane, for example: either of aliphatic and/or aromatic polyester type, preferably mostly aliphatic, especially derived from aliphatic glycols, possibly diethylene glycol, and from aliphatic and/or aromatic acids; or

of polyether type, especially polyethylene oxide and/or polypropylene oxide or polytetrahydrofuran.

The polyol or polyol-polyamine constituent is advantageously an oligomer with a molecular weight of around 10 000 g/mol or less, preferably of about 500 to 4 000 g/mol, and particularly from 1 500 to 3 500 g/mol.

Its functionality is preferably about 2 as an upper value, and particularly from 1 500 to 3 500 g/mol.

Constituent (B) may be chosen from simple molecules, in particular aromatic molecules, having at least two isocyanate functional groups, and also oligomers (of molecular weights which may especially be chosen from the abovementioned ranges), the above isocyanates modified in the form of prepolymers, and isocyanate prepolymers, these oligomers and prepolymers, of functionality at least equal to 2, having isocyanate end groups.

The isocyante or isocyanates forming constituent (B) may thus be chosen from para-phenylene diisocyanate, trans-1,4-cyclohexane diisocyanate, 3-isocyanatomethyl-3,3,5-trimethylcyclohexyl isocyanate, 1,5-naphthalene diisocyanate, methylenebis-(4-phenyl isocyanate) (pure MDI), crude MDI, toluene 2,4-diisocyanate (2,4-TDI), toluene 2,6-diisocyanate (2,6-TDI) and their mixtures, such as 80/20 TDI comprising 80% of the 2,4 isomer or 65/35 TDI, and also crude TDI (unpurified 80/20 TDI).

Among these compounds, crude or pure MDI or a mixture of the two is most particularly preferred.

For the isocyanate compound, the functionality is preferably about 2 as an upper value, particularly about 2 to 2.8.

The composition according to the invention may comprise, in addition, at least one conventional additive chosen from: particulate or pulverulent, organic or mineral fillers such as calcium carbonate and carbon black; plasticizers, colorants, stabilizers, surfactants, cell regulators and catalysts, said additive or additives usually being combined with constituent (A).

The term “filler” is understood to mean here, in a general way, a product that is neither soluble in nor miscible with the polymer matrix, but is dispersible in the latter, making it possible to improve one or more properties or characteristics (mechanical properties, chemical properties, color, production cost) of the final compound.

In compliance with a first embodiment of the composition according to the invention, the composition is in the form of a viscous paste (one-component product) consisting of the polyurethane prepolymer having isocyanate end groups resulting from the reaction between constituents (A) and (B) with possible incorporation of at least one additive.

Such a reaction is well known to those skilled in the art, the reaction temperatures and times varying according to the constituents used.

The polyurethane prepolymer having isocyanate end groups may, according to one variant, have undergone a trialkoxysilylation reaction to yield a polyurethane prepolymer with trialkoxysilyl end groups. A trialkoxysilane capable of reacting with an NCO group may be a trialkoxyaminosilane, for example, an aminopropyltrialkoxysilane such as aminopropyltrimethoxysilane or even a trialkoxymercaptosilane.

In compliance with a second embodiment of the composition according to the invention, constituents (A) and (B) are intended to be mixed just before use (two-component system), in the presence of water as foaming agent, said mixture then being extruded at the time of application onto the part or support to give the cellular material.

Yet another subject of the invention is a process for manufacturing a cellular material by extrusion of a composition as is defined above, characterized in that it comprises steps consisting:

a) preparing a polyurethane prepolymer by the reaction of constituents (A) and (B) such as those defined above (one-component product);

b) possibly storing said one-component product away from moisture;

c) mixing said product with a pressurized gas to form an extrudable material;

d) extruding a quantity of extrudable material in order to obtain an extruded material, the foaming of which has been activated; and

e) proceeding with the foaming, and crosslinking the extruded material in a humid atmosphere.

The pressurized gas may be preferably nitrogen, but also any other gas known for this purpose, namely air, carbon dioxide, n-pentane, etc.

The crosslinking treatment in a humid atmosphere may be carried out under conditions known to those skilled in the art, for example in a temperature range from room temperature to 80° C. and in an atmosphere having a relative humidity of about 40 to 100%.

The present invention also relates to a process for manufacturing a cellular material by extrusion of a composition such as is defined above, characterized in that it comprises steps consisting:

a) mixing, in the presence of water, the two constituents (A) and (B) which, stored separately, form a two-component system, so as to obtain an extrudable material, the water having been added to constituent
(A) from the start or being introduced only at the time of mixing;

b) extruding a quantity of extrudable material; and

c) letting the crosslinking proceed in the open air or in a controlled environment.

At step d) of the first abovementioned process or at step b) of the second abovementioned process, the extrudable material may be deposited on a part that is intended to receive it, in particular, said material may be deposited as a band, or a strand or a ring in order to form a sealing, insulating or damping seal on said part.

It could also be possible to envisage an extrusion into a mold that has a nonstick surface bearing the negative imprint of the surface of the part, followed by transfer onto this surface.

At step d) of the first abovementioned process or at step b) of the second abovementioned process, the extrudable material may also be deposited as a band, a layer or a disk on a support such as paper or a glass fabric impregnated with silicone, a fluorinated product, etc., or a plastic film, the support/extruded material assembly may possibly be passed between two rolls, to control the thickness of the extruded material, and then the foamed extruded material, possibly cut into the desired shapes and sizes for the sealing, insulating or dampening seal, may be detached.

The term “extrusion” is understood to mean here, in the broad sense, a technique in which a material in the fluid or viscous state is transported to an application orifice or nozzle. This term does not limit the invention to a technique for conforming the material, the latter being free to adopt, on exiting the orifice, dimensions substantially different from those of the nozzle outlet.

Finally, the present invention also relates to a hydrolysis-resistant cellular material, obtained by extrusion of a polyurethane prepolymer having isocyanate end groups, foaming having been carried out by injection of pressurized gas and/or by chemical reaction between water and said isocyanate end groups, at least one polyol (P) is chosen from polyester and polyether polyols grafted by chains of at least one of the following: polystyrene, polyacrylonitrile and styrene/acrylonitrile copolymers and from polyester and polyether polyols in which at least one of the following: polystyrene, polyacrylonitrile and styrene/acrylonitrile copolymers is dispersed, being incorporated into the formulation of the polyol constituent or of the polyol-polyamine constituent of a polyurethane forming the polymer matrix of said cellular material, said polyol or polyols (P) representing at least one part of said polyol constituent or at least one part of the polyol fraction of said polyol-polyamine constituent.

The cellular material is advantageously in the form of a strip, a sheet, a strand or a tube for a sealing, insulating or damping seal.

It may have been firmly attached to the part to which it is intended to be applied in order to ensure sealing, the reverse part then becoming fixed to the part/seal assembly by any mechanical means suitable for compressing the seal.

The following examples illustrate the present invention without however limiting the scope thereof. In these examples, the percentages are given by weight, except where otherwise indicated.

### EXAMPLE 1

### Preparation of a Polyurethane Prepolymer

A polyurethane prepolymer was prepared by reacting a polyether grafted by a styrene/acrylonitrile copolymer with methylenebis(4-phenyl isocyanate) (MDI). This graft polyether is the one sold in the LUPRANOL range by BASF; it is characterized by an OH number of around 19.8 (expressed in mg of KOH per gram of product). The MDI used was a mixture of pure MDI having a functionality of 2 and a content of isocyanate NCO groups of 33.5% (in wt % of NCO equivalents per gram of product) and crude MDI having a functionality of 2.7 and a content of isocyanate NCO groups of 31.5% (in wt % of NCO equivalents per gram of product). The crude MDI represented 24% by weight of the total weight of isocyanates.

50 kg of LUPRANOL were placed in a mixer with surface flushing by dry air and were heated to a temperature of about 95° C.

5.8 kg of pure MDI and 1.8 kg of crude MDI were then added so that the initial NCO/OH molar ratio was 3.4, and the mixture was homogenized with moderate stirring.

When the theoretical NCO percentage content was reached, an amine-type catalyst, in an amount of 0.275% of the product, 0.4% of carbon black and 0.25% of a silicone surfactant were added. After homogenizing, the product was rapidly packaged under a dry atmosphere.

### Manufacture of a Cellular Material

The one-component product prepared above was extruded in the presence of pressurized nitrogen in a foaming machine of the type disclosed in EP-A-0 654 297, comprising:

a stock of the product and means of heating said product to the extrusion temperature;

a mixer device fitted with a delivery tube for the viscous product and a delivery tube for the pressurized nitrogen; and

a delivery tube for the extrudable material equipped with a extrusion nozzle.

Under the effect of the temperature and pressure in the chamber of the mixing device, the nitrogen dissolved in the one-component product. At the exit of the extrusion nozzle, the material was exposed to atmospheric pressure, the reduction in pressure bringing about the release of nitrogen with the formation of gas bubbles that expanded the polymer.

The extrusion conditions were adapted in order to form an extruded strand of around 6 mm in diameter. The nozzle was heated to 35° C. so as to keep the viscosity of the material at the desired value on exiting the extrusion channel.

The extrusion operation was followed by a step of crosslinking the extruded strand in a humid atmosphere under two types of conditions: at room temperature and at a relative humidity of about 50 to 60%, or else in a hot atmosphere, for example at a temperature of 55° C. to 60° C., and at a relative humidity of 85% to 95% in a suitable chamber.

### Elongation Measurements

The elongation of the cellular material as obtained was measured and then measured after hydrolysis (15 h in an autoclave at 120° C. in a moisture-saturated atmosphere under the conditions of the ISO 2440 standard).

The elongation was measured on 6 mm diameter rods in accordance with the DIN 53571 standard, with a pull rate of 300 mm/minute and a 100 mm gap between the jaws.

### EXAMPLES 2 TO 4 OF THE INVENTION

The method of example 1 was followed (same NCO/OH molar ratio) except that in place of the graft polyol, this same graft polyol was used as a blend with a polyether based on an ethylene oxide/propylene oxide mixture. The polyether based on an ethylene oxide/propylene oxide mixture was the one sold under the trademark LUPRANOL by BASF; it is characterized by an OH number of around 28 (expressed in mg of KOH per gram of product).

Examples 2 to 4 were differentiated by the relative proportions of these two constituents. The quantities (in kg) of these constituents are given in the following table:

| | Graft polyol | Ungrafted polyol |
|---|---|---|
| Example 2 | 12.8 | 1.4 |
| Example 3 | 4.7 | 9.5 |
| Example 4 | 2.2 | 12.0 |

### COMPARATIVE EXAMPLE

The methods of example 1 to 4 were followed except that the polyol phase was composed only of polyether based on an ethylene oxide/propylene oxide mixture.

Evaluation of the Hydrolytic Degradation of the Cellular Materials by the Change in their Elongation Value.

Hydrolysis of a cellular material destroys the chains of the polyurethane matrix, which leads to an increase in the elongation of said material. In other words, the less a material is degraded, the smaller its variation in elongation.

The table below shows, for each of the examples of the invention, the percentage variation in elongation normalized with respect to the variation in elongation obtained with the cellular material of the comparative example.

This table also shows the height shrinkage or loss of height (in %) of the seal after the same aging.

TABLE

| | | | | | Comparative |
|---|---|---|---|---|---|
| | Example 1 | Example 2 | Example 3 | Example 4 | example |
| Percentage | <1 | <2 | 15-25 | 40-60 | 100 |
| variation | | | | | |
| in | | | | | |
| elongation | | | | | |
| Shrinkage | <5 | <5 | <5 | 16 | >>20 |
| (%) | | | | | |

This table clearly shows that the presence of polyether grafted by a styrene/acrylonitrile copolymer greatly reduces the degradation of the polyether chains.

1. A method of incorporating into the formulation of the polyol constituent or of the polyol-polyamine constitutent of a polyurethane forming the polymer matrix of a hydrolysis-resistant soft cellular material at least one polyol (P) chosen from polyester and polyether polyols grafted by chains of at least one of the following: polystyrene, polyacrylonitrile and styrene/acrylonitrile copolymers and from polyester and polyether polyols in which at least one of the following: polystyrene, polyacrylonitrile and styrene/acrylonitrile copolymers is dispersed, said polyol or polyols (P) representing at least one part of said polyol constituent or at least one part of the polyol fraction of said polyol-polyamine constituent.

2. The method as claimed in claim 1, characterized in that the polyol (P) is chosen from a polyester or polyether polyol grafted by chains of at least one of the following: polystyrene, polyacrylonitrile and styrene/acrylonitrile copolymers, the latter being block or random copolymers or a combination of the two.

3. The method as claimed in either of claims 1, characterized in that the polyol (P) is chosen from a graft polyester or polyether polyol, in which the backbone of the graft is a poly(ethylene oxide), a poly(propylene oxide) or a poly(propylene oxide/ethylene oxide).

4. The method as claimed in claim 1, characterized in that the polyol or polyols (P) represent at least 5% by weight of the polyol constituent or of the polyol-polyamine constituent of the polyurethane prepolymer.

5. The method as claimed in claim 1, characterized in that the cellular material is in strip, sheet, strand or tube form for a seal, or part of a seal, for sealing, insulating or damping.

6. A composition intended to form the polyurethane polymer matrix of a hydrolysis-resistant soft cellular material, characterized in that it comprises:
(A) a polyol constituent formed from at least one polyol of functionality at least equal to 2 or a polyol-polyamine constituent formed from at least one polyol of functionality at least equal to 2 and from at least one polyamine of functionality at least equal to 2, at least one part of said polyol constituent or of the polyol fraction of said polyol-polyamine constituent being formed by at least one polyol (P) chosen from polyester and polyether polyols grafted by chains of at least one of the following: polystyrene, polyacrylonitrile and styrene/acrylonitrile copolymers and from polyester and polyether polyols in which at least one of the following: polystyrene, polyacrylonitrile and styrene/acrylonitrile copolymers is dispersed; and
(B) a polyisocyanate constituent,
the quantities of constituents (A) and (B) being especially chosen in such a way that said constituents (A) and (B) are able to react in an NCO/(OH+NH₂) molar ratio of at least 2.

7. The composition as claimed in claim 6, characterized in that the polyol or polyols other than the polyols (P) and the polyamines capable of being incorporated into the formulation of constituent (A) are chosen from the polyols and polyamines respectively having a backbone of the type: polyester; polycaprolactone; polyether; polyolefin, especially hydroxylated EVA copolymer; saturated or unsaturated polybutadiene; polyisoprene; and polydimethylsiloxane and being
either of aliphatic and/or aromatic polyester type derived from aliphatic glycols, and from aliphatic and/or aromatic acids; or
of polyether type.

8. The composition as claimed in claim 6, characterized in that the polyisocyanate or polyisocyanates forming constituent (B) are chosen from simple aromatic molecules, having at least two isocyanate functional groups, and also oligomers, the above isocyanates modified in the form of prepolymers, and isocyanate prepolymers, these oligomers and prepolymers, of functionality at least equal to 2, having isocyanate end groups, said isocyanates being chosen from para-phenylene diisocyanate, trans-1,4-cyclohexane diisocyanate, 3-isocyanatomethyl-3,3,5-trimethylcyclohexyl isocyanate, 1,5-naphthalene diisocyanate, methylenebis(4-phenyl isocyanate) (pure MDI), crude MDI, toluene 2,4-diisocyanate (2,4-TDI), toluene 2,6-diisocyanate (2,6-TDI) and mixtures thereof.

9. The composition as claimed in claim 6, characterized in that it comprises, in addition, at least one conventional additive chosen from: particulate or pulverulent, organic or mineral fillers; plasticizers, colorants, stabilizers, surfactants, cell regulators and catalysts, said additive or additives optionally being combined with constituent (A).

10. The composition as claimed in claim 6, characterized in that it is in the form of a viscous paste (one-component product) consisting of the polyurethane prepolymer having isocyanate end groups resulting from the reaction between constituents (A) and (B) with optionally the incorporation of at least one additive.

11. The composition as claimed in claim 10, characterized in that the polyurethane prepolymer having isocyanate end groups has undergone a trialkoxysilylation reaction to yield a polyurethane prepolymer having trialkoxysilyl end groups.

12. The composition as claimed in claim 6, characterized in that constituents (A) and (B) are intended to be mixed just before use (two-component system) in the presence of water as foaming agent, said mixture then being extruded at the time of application onto the part or support to give the cellular material.

13. A process for manufacturing a cellular material by extrusion of a composition as is defined claim 6, characterized in that it comprises steps that consist in:
a) preparing a polyurethane prepolymer by the reaction of constituents (A) and (B) resulting in a one-component product;
b) optionally storing said one-component product away from moisture;
c) mixing said product with a pressurized gas in order to form an extrudable material;
d) extruding a quantity of extrudable material in order to obtain an extruded material, while activating the foaming of said material; and
e) proceeding with the foaming, and crosslinking the extruded material in a humid atmosphere.

14. A process for manufacturing a cellular material by extrusion of a composition as is defined in claim 6, characterized in that it comprises steps that consist in:
a) mixing, in the presence of water, the two constituents (A) and (B) which, stored separately, form a two-component system, so as to obtain an extrudable material, water having been added to constituent (A) from the start or being introduced only at the time of mixing;
b) extruding a quantity of extrudable material; and
c) letting the crosslinking proceed in the open air or in a controlled environment.

15-19. (canceled)

20. The process as claimed in claim 13, characterized in that, at step d) of the process the extrudable material is deposited as a strip, a strand or a ring on a part that is intended to receive it in order to form a sealing, insulating or damping seal on said part.

21. The process as claimed in claim 13, characterized in that, at step d) of the process the extrudable material is deposited as a strip, a layer or a disk on a paper or glass fabric support impregnated with silicone or with a fluorinated product, or on a plastic film, the support/extruded material assembly is optionally passed between two rolls to control the thickness of the extruded material, and then the foamed extruded material is optionally cut into desired shapes and sizes and detached for use as a sealing, insulating or dampening seal.

22. The process as claimed in claim 14, characterized in that, at step b) of the process the extrudable material is deposited as a strip, a strand or a ring on a part that is intended to receive it in order to form a sealing, insulating or damping seal on said part.

23. The process as claimed in claim 14, characterized in that, at step b) of the process the extrudable material is deposited as a strip, a layer or a disk on a paper or glass fabric support impregnated with silicone or with a fluorinated product, or on a plastic film, the support/extruded material assembly is optionally passed between two rolls to control the thickness of the extruded material, and then the foamed extruded material is optionally cut into desired shapes and sizes and detached for use as a sealing, insulating or dampening seal.

24. A hydrolysis-resistant cellular material, obtained by extrusion of a polyurethane prepolymer having isocyanate end groups, foaming having been carried out by injection of pressurized gas and/or by chemical reaction between water and said isocyanate end groups, wherein at least one polyol (P), chosen from polyester and polyether polyols grafted by chains of at least one of the following: polystyrene, polyacrylonitrile and styrene/acrylonitrile copolymers and from polyester and polyether polyols in which at least one of the following: polystyrene, polyacrylonitrile and styrene/acrylonitrile copolymers is dispersed, is incorporated into the formulation of the polyol constituent or of the polyolpolyamine constituent of a polyurethane forming the polymer matrix of said cellular material, said polyol or polyols (P) representing at least one part of said polyol constituent or at least one part of the polyol fraction of said polyol-polyamine constituent.

25. The cellular material as claimed in claim 24, in the form of a strip, a sheet, a strand or a tube for use as a sealing, insulating or damping seal.

26. The cellular material as claimed in claim 25, characterized in that it is firmly attached to the part to which it is intended to be applied.
